(19) United States
(12) Patent Application Publication
(10) Pub. No.: US 2025/0128443 A1
(43) Pub. Date: Apr. 24, 2025

(54) INDUSTRIAL KNIFE WITH A BASE BODY AND AN EXCHANGEABLE CUTTING EDGE PART

(71) Applicant: ASTOR Schneidwerkzeuge GmbH, Storkow (DE)

(72) Inventor: Romano Förster, Fürstenwalde/Spree (DE)

(21) Appl. No.: 18/920,819

(22) Filed: Oct. 18, 2024

(30) Foreign Application Priority Data
Oct. 20, 2023 (DE) 102023128849.0

(51) Int. Cl. B26D 1/00; B26D 7/26

(52) U.S. Cl. CPC B26D 1/0006; B26D 7/2614; B26D 2001/0053; B26D 2210/02

(57) ABSTRACT

The invention relates to an industrial knife with a base body and an exchangeable cutting edge part, wherein the cutting edge part can be coupled in a non-positive and/or positive manner to a base body surface, as well as with at least one connection means. According to the invention, the connection means is formed as mold body, which has a web and two opposite mold heads, wherein a notch, which is complementary to the respective mold head and in each case merges into a channel or into a groove in the direction of a coupling surface, is in each case present in the base body and in the cutting edge part.

The invention relates to an industrial knife with a base body and an exchangeable cutting edge part, wherein the cutting edge part can be coupled in a non-positive and/or positive manner to a base body surface, as well as with at least one connection means according to the preamble of claim 1.

A cutting knife, which has a knife holder with a releasably fastened knife blade, is already known from the DE 10 2022 102 557 A1.

The knife blade is mounted in a non-positive and positive manner on the knife holder, for the purpose of which the knife blade has a cutting edge region and a clamping region and is mounted in a clamping manner in the clamping region between two clamping bodies of the knife holder. Positive-locking elements, which engage with one another in the assembled state of the cutting knife, are formed on the knife blade and on the knife holder in a corresponding manner.

Two notches in the form of at least two grooves are present on the knife blade side, wherein at least two elevations, which are formed in a corresponding manner, are present on the knife holder side. They have a conical shape. In the assembled state of the cutting knife, the cones engage with the grooves.

The clamping of the two clamping bodies with one another takes place by means of an additional screw connection.

A solution of this type of an exchangeable cutting edge for a knife has several gaps as well as protrusions and recesses, which can receive contaminations or which are to be cleaned only after complete assembly, respectively, which rules out a transfer of a connection technology of this type for industrial knifes in the field of food processing.

In the case of the knife for cutting machines according to DE 203 13 038 U1, the knife consists of a knife base body and an assigned cutting body with corresponding cutting edges. The cutting body is connected in a non-positive and positive manner via a joining point provided between the knife base body and the cutting body. The joining point can be designed, for example, as tongue and groove connection. In order to ensure a reliable connection, a joining means is to additionally be introduced.

It has been shown, however, that a connection in the manner of a tongue and groove coupling cannot be used for heavy-duty industrial knives. The use of a joining means in the form of an adhesive additionally proves to be problematic in the food processing industry.

This is so because the food processing industry faces the challenge of working according to the highest hygiene standard on the one hand, but also of being able to operate in an economically efficient manner on the other hand.

In order to comply with common requirements, disposable knives were used in the past, which consist of a single material and which are discarded after each use.

The use of re-usable knives with exchangeable cutting blades presents itself as alternative here.

In the case of such a solution, the base body of the knife is maintained, which is thoroughly cleaned and disinfected after each use.

The cutting blade of the knife, which is in fact used the most, can be exchanged easily. The base body can thus be used for a longer period of time and the waste is reduced. Exchangeable cutting blades thus provide a cost-efficient solution.

As can be understood from the prior art outlined briefly at the start, however, the connection method of the components base body and cutting blade is of particular importance. The connection of the components is to be possible easily and cost-efficiently and is to furthermore lead to an extremely small gap width at the corresponding connection or coupling surface.

From the afore-mentioned, it is thus the object of the invention to specify a further developed industrial knife or a connection means, respectively, which minimizes the gap distance between the fundamentally existing coupling surfaces due to the connection process, without creating increased expenditures in response to the provided re-use of the base body or of the replacement of the cutting edge part, respectively.

The object of the invention is solved with the feature combination according to claim 1 or the use according to the invention of the connection means according to claim 11, respectively, wherein subclaims comprise at least expedient designs and further developments.

According to this, the starting point is an industrial knife with a base body and an exchangeable cutting edge part, wherein the cutting edge part can be coupled in a non-positive and/or positive manner to a base body surface. At least one connection means for coupling base body and cutting edge part is furthermore provided.

According to the invention, the connection means is formed as mold body, which has a web and two opposite mold heads, wherein a notch, which is complementary to the respective mold head, is in each case present in the base body and cutting edge part. This notch, which is provided in each case, merges into a channel or a groove in the direction of a coupling surface.

The corresponding channel or the respective groove, respectively, thus starts at the coupling surface and reaches all the way into the notch, which is complementary to the respective mold head.

The notch and the respective channel or the respective groove form a hollow space, into which the mold body can be introduced.

According to a first embodiment, the mold body has means for generating a clamping or pressing force between the mold heads and thus the coupling surface as well as the base body and the cutting edge part.

These means can comprise a screw or bolt connection, including the web.

In this respect, a mold head can have a bore with an internal thread, with which a screw bolt engages, which is provided with a corresponding external thread. The screw bolt engages through a bore in the second one of the mold heads and has a screw head. If a workpiece is now attached to the screw head, a clamping force can be applied to the mold heads, which lie in the respective notches. As a result, base body and cutting edge part are pressed against one another in the region of the coupling surface with a minimization of the gap, which is present there.

In this respect, the notches in the base body and/or in the cutting edge part have an access for actuating the screw or bolt connection.

The respective notch can have, for example, a circular shape, a pitch circle shape but also a polygonal shape. As already described, the gap distance between the base body surface and the respective opposite surface of the cutting edge part can be minimized via the connection means. The ingress of contaminations during the use of a corresponding knife is effectively prevented hereby.

In the case of a preferred embodiment, the base body surface and the cutting edge part form a coupling surface, which is embodied edge to edge.

A supporting guide or bearing surface or a corresponding surface section can additionally be formed below or above the coupling surface, which is embodied edge to edge.

In the case of a second embodiment of the invention, the mold body consists of a hardening, initially liquid mass, which can be introduced into the hollow space.

The filler is subject to a shrinkage during the hardening process. This leads to a clamping force between base body and cutting edge part, whereby the coupling surface gap is likewise subject to a minimization.

In the case of the formation of the connection means according to the first embodiment, a remaining hollow space can be closed with a food-safe filler, whereby the connection element is concealable.

This food-safe filler furthermore secures the bolt or screw connection against unwanted loosening.

According to the invention, the connection means embodiment with screw or bolt combination can be combined with an additional connection means on the basis of a hardening filler in order to create an additional positive connection element.

The invention will be described in more detail below on the basis of exemplary embodiments as well as with the help of figures, in which:

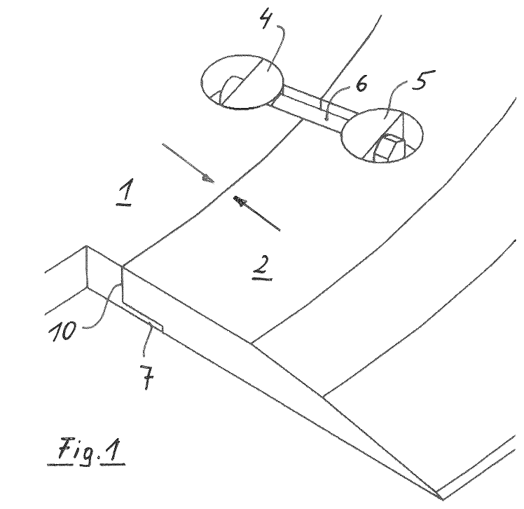

FIG. 1 shows an exemplary illustration of a portion of an industrial knife base body with coupled cutting edge part and connection means according to the invention as well as with additional bearing surface in the region of the coupling surface;

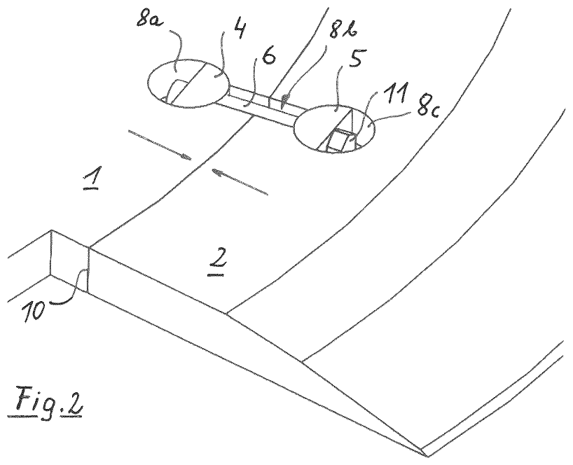

FIG. 2 shows an illustration similar to the one according to FIG. 1, but with a coupling surface embodied perpendicular to the force action direction (arrow illustration) without additional support;

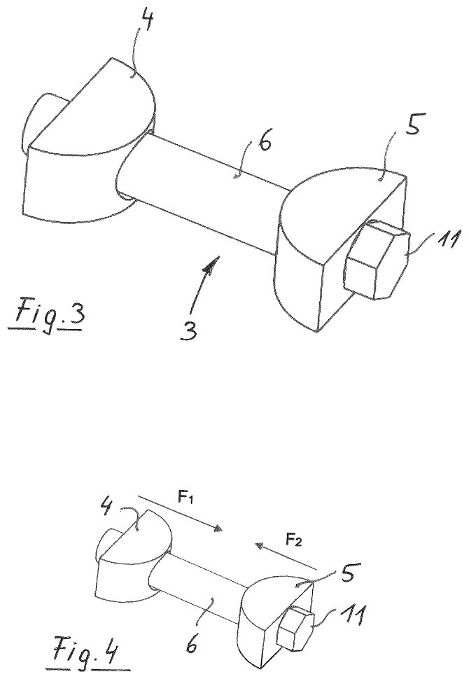

FIG. 3 shows a perspective illustration of an exemplary connection element on the basis of a screw or bolt connection;

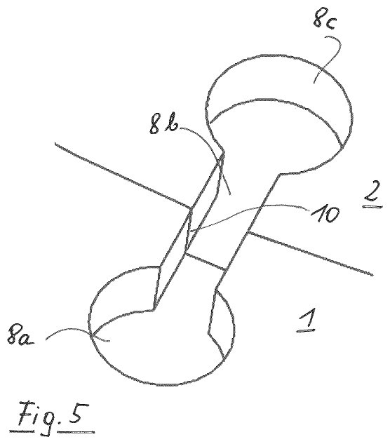

FIG. 4 shows a perspective illustration of the connection element according to FIG. 3 with suggested force action direction F1 or F2, respectively; and

FIG. 5 shows an exemplary formation of notch and channel or groove and the hollow spaces created hereby in these elements to be connected, namely the base body and the exchangeable cutting edge part.

The industrial knife shown as cutout in FIGS. 1 and 2 has a base body 1 and an exchangeable cutting edge part 2.

The cutting edge part 2 can be coupled in a non-positive and/or positive manner to a surface of the base body 1. A connection means or connection element 3 (see FIG. 3) is additionally provided.

In the illustration according to FIG. 1, a bearing surface 7 is also present in the region of the coupling surface 10.

This bearing surface 7 supports the positioning and thus the positive connection between base body 1 and cutting edge part 2.

The arrow illustrations in FIGS. 1 and 2 symbolize the force action direction by using the connection means 3 in order to minimize the gap in the region of the coupling surface 10.

In the case of the illustration according to FIG. 2, no additional bearing surface is present in the region of the coupling surface 10. As a whole, the notches 8a and 8c as well as the channel or the groove 8b, respectively, form a hollow space with different hollow space chambers.

After inserting the connection means 3 into the notch or the aligned grooves 8b, respectively, and after exerting the corresponding clamping force for generating a corresponding compression in the region of the coupling surface 10, the remaining hollow spaces 8a, 8b and 8c can be filled with a food-safe mass.

This mass, which is not shown in the figures, can simultaneously also be used to secure the attained non-positive connection, that is, against a loosening of the screw connection with screw head 11.

FIG. 3 now shows an exemplary connection means 3 with web 6 and opposite mold heads 4 and 5.

The web 6 can be embodied as bolt or screw-like connector here.

By utilizing the screw head 11, the distance between the mold heads 4 and 5 can be reduced in the case of corresponding threaded sections, which are embodied in an expert manner.

If the connection means 3 is located in the notches or the grooves, respectively, according to the illustrations according to FIGS. 1 and 2, the necessary pressing and clamping forces can be generated.

The force direction effects by using the connection means 3 are suggested in FIG. 4.

FIG. 5 shows an exemplary formation of the notches 8a and 8c or of the grooves, respectively, or groove sections 8b and the hollow spaces resulting therefrom.

It is possible to carry out the necessary connection between base body and cutting edge part without a connection means 3 according to FIGS. 1 to 4 being used.

The hollow space, which is illustrated according to FIG. 5, can be provided with a food-safe filler in this case. In the hardened state of this mass, a positive connection element then results.

In summary, the base body 1 and the cutting edge part 2 are thus connected to one another in a non-positive manner on their respective abutment surfaces or coupling surfaces, respectively, by means of the connection means 3.

Alternatively, the connection can be realized by means of an additional bearing surface 7 via a positive connection, which acts in the direction of the applied forces F1 or F2.

1. An industrial knife with a base body (1) and an exchangeable cutting edge part (2), wherein the cutting edge part (2) can be coupled in a non-positive and/or positive manner to a base body surface, as well as with at least one connection means (3),
characterized in that
the connection means (3) is formed as mold body, which has a web (6) and two opposite mold heads (4; 5), wherein a notch (8a; 8c), which is complementary to the respective mold head (4; 5) and in each case merges into a channel or a groove (8b) in the direction of a coupling surface (10), is in each case present in the base body (1) and in the cutting edge part (2).

2. The industrial knife according to claim 1,
characterized in that
the notches (8a; 8c) and the respective channel (8b) or the respective groove form an accessible hollow space, into which the mold body can be introduced.

3. The industrial knife according to claim 1,
characterized in that
the mold body has means for generating a clamping force (F1; F2) between the mold heads (4; 5) and thus the coupling surface (10) as well as the base body (1) and the cutting edge part (2).

4. The industrial knife according to claim 3,
characterized in that
the means comprise a screw or bolt connection, including the web (6).

5. The industrial knife according to claim 4,
characterized in that
the notch (8a; 8c) in the base body (1) and/or in the cutting edge part (2) have an access for actuating the screw or bolt connection, in particular to a screw head (11).

6. The industrial knife according to claim 1,
characterized in that
the respective notch (8a; 8c) has a circular shape, a pitch circle shape or a polygonal shape.

7. The industrial knife according to claim 1,
characterized in that
a gap distance between the base body surface and the opposite surface of the cutting edge part (2) can be minimized via the connection means (3).

8. The industrial knife according to claim 1,
characterized in that
the base body surface and the cutting edge part form a coupling surface (10), which is embodied edge to edge.

9. The industrial knife according to claim 8,
characterized in that
supporting guide or bearing surfaces or surface sections (7) are additionally formed below or above the coupling surface (10), which is embodied edge to edge.

10. The industrial knife according to claim 2,
characterized in that
the mold body is formed of a hardening, initially liquid mass, which is introduced into the hollow space.

11. A connection means according to claim 1,
characterized by
the use thereof for re-usable industrial knives with exchangeable cutting blade in the food processing industry.
